(19) United States
(12) Patent Application Publication
(10) Pub. No.: US 2003/0163467 A1
(43) Pub. Date: Aug. 28, 2003

(54) Metric based reorganization of data

(76) Inventor: Robert Cazier, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/087,094

(22) Filed: Feb. 27, 2002

(51) Int. Cl. G06F 7/00

(52) U.S. Cl. 707/7

(57) ABSTRACT

A system that uses a sorting criteria and a sorting size to reorganize data.

### RELATED APPLICATIONS

The application “Automatic directory creation for GPS enabled image management” that was filed on Oct. 13, 2000 and has application Ser. No. 09/687818 is related to this application and is hereby incorporated by reference.

### FIELD OF THE INVENTION

The field of this invention relates to data management and more specifically to automatic reorganization of data.

### BACKGROUND OF THE INVENTION

Digital cameras create a large number of files. These files can be audio files, thumbnails or full digital images. Currently these files are named based on a default name given by the camera manufacture, for example DSC00001.jpg. Most digital cameras today can store a large number of these images. After taking pictures the user is presented with a list of these files with names that have no meaning to the user, for example DSC00001.jpg, DSC00002.jpg, DSC00003.jpg, DSC00004.jpg etc. Typically theses files are stored at one level in one directory (i.e. without any sub-directories). When the user transfers the image files to a computer, the files are also stored typically at one level or in one folder that contains all the user's images. This can create a single sub-directory or folder that contains a large number of image files. Managing these files can be difficult.

Some cameras allow the user to rename the file but with the limited user interface available on most digital cameras, renaming the file is difficult and time consuming.

There is a need for a system that can automatically reorganize the files into sub-directories, based on selectable criteria, to help manage the image files.

### SUMMARY OF THE INVENTION

An image management system can improve the organization and retrieval of image files by automatically creating sub-directories. The sub-directories for the storage of the image files would be created based on a sorting criteria and a sorting size.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a flow chart for metric based reorganization of data in accordance with one embodiment of the present invention.

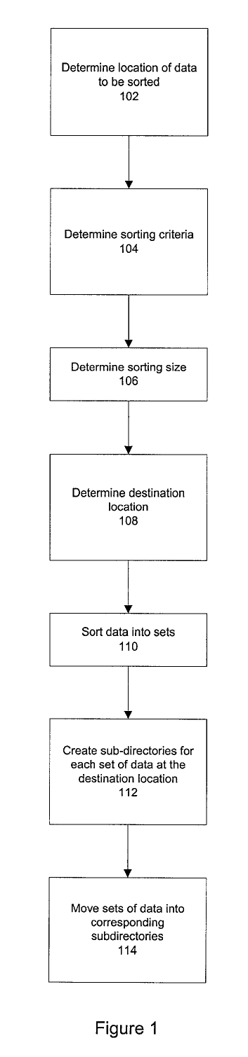

### DETAILED DESCRIPTION OF THE PREFERRED EMBODIMENT

A system that can automatically create sub-directories (also called folders) and sort data into those sub-directories, based on a sorting criteria and a sorting size, greatly enhance the users ability to manage the data.

Digital cameras today typically have a storage area for storing image files created by the camera. Some cameras use removable storage areas, for example a floppy disc or a memory card. Typically all the image files are stored at one level in the same directory. When a user connects the camera or storage area to a computer or storage on the Internet, the files are typically moved into one folder or sub-directory. A user can manually move individual files or images or groups of files into separate subdirectories, but with the number of images a typical camera can store, this is a tedious process.

An image file typically contains more information than just the raw image data. Most image files also contain the time and date the file was created. Many image files also contain information about the image, for example the resolution of the image, the exposure settings used to capture the image, whether the image has been compressed, and if so how much compression was used. Some cameras contain global positioning systems (GPS) and include, in the image file, the location the file was created. The global positioning system (GPS) is a system that allows a GPS device to determine the longitude and latitude of the device to within approximately 3 meters, anywhere in the world. Today some digital cameras have GPS auxiliary devices that allow the digital camera to embed the longitude and latitude information into the image or save the longitude and latitude as meta-data in the image file. This longitude and latitude information is not very user friendly. Most people do not know the location name that corresponds to any given longitude and latitude.

A GPS database may be a database that has a set of names and/or addresses that correspond to a set of longitude and latitudes. There are many different GPS databases. Some databases are sets of addresses that correspond to roads in an area, for example the roads in the State of Colorado. Some GPS databases have sets of names for each town and city in an area. One GPS database has a set of names that correspond to the range, township, and section for the United States. Some GPS databases are large. Typically these large GPS databases are segmented into areas. For example, a large GPS database for the U.S. is segmented by States. Each segment can be loaded or used independent from the other segments. Once a GPS device determines the longitude and latitude of the device a GPS database can be used to translate the longitude and latitude information into the name of the location or the address of the location, for example the name of the city or the name of the street address corresponding to the longitude and latitude information. Some remote areas in the U.S. are not near any cities or roads, in these cases the name of the range, township and section could be used. Another option for remote areas is to name them relative to the nearest landmark, for example 3 miles north west of the North Rim Lodge of the Grand Canyon.

Cameras today may allow the user to mark or tag images with information that helps the user sort or manage the images. For example, the camera may store a list of names of commonly photographed people. When the user takes a picture of one of the people on the list, the user can mark or tag that image with the person's name. Cameras may also contain a list of e-mail destination. The user can mark an image to be sent to one or more of these e-mail destinations. When the camera is connected to a computer or the Internet, a copy of the image is automatically sent to the e-mail destination. An e-mail destination may be a list or group, for example, “my family members”. There are many other types of information that can be included in an image file, the examples given are for ease of understanding and do not limit the invention to the types of information used in the examples.

When the camera or storage area is connected to a computer or the Internet, the additional information contained in the image files can be used to sort the images into groups or sets of files. Sub-directories or folders can be created for each set of image files and the image files can be moved into their corresponding sub-directories.

In one embodiment of the current invention, a sorting criteria and a sorting size are used to sort the image files into sets of image files. The sorting criteria can be any of the information stored with the image files. The sorting size is dependant on the sorting criteria. When the sorting criteria is time, the sorting size may be duration. An example sorting size when time is the sorting criteria could be 5 days. Using the sorting criteria and sorting size, the images are sorted into sets of images. For example, any image created within 5 days of the first image created would be grouped into the set with the first created image. Any 5-day period that does not contain an image would be a null set, and no sub-directory would be created.

When the sorting criteria is location, the sorting size may be a distance or may be a geographic designation, for example a city. When the sorting size is a city, all the images captured in a city would be grouped together in one set. Any images captured outside a city boundary may be grouped into a non-city set or a rural set, or a metropolitan set

When the sorting criteria is people, the sorting size may be an individual, or it may be a group, for example, “my family”. When the sorting size is an individual, all the images of each person would be moved into a sub-directory for that person. When the sorting size is a group, any image of any people in the group would be moved into the sub-directory for that group.

In one embodiment of the current invention, a list of the possible sorting criteria is created when the camera or storage area is connected to a computer or the Internet. The list is created by examining the images on the camera or storage area to determine the types of information stored with the image files. When the time the file was created has been stored with the image file, time may be available as a sorting criteria. Some types of data may not be presented as a sorting criteria even when that data is available in the image files, for example the image may contain information on if the flash was used in capturing an image, this does not need to be presented as a sorting criteria. The user may choose a sorting criteria from the list of sorting criteria, or a default sorting criteria may be used. In another embodiment of the current invention, the list of sorting criteria is created on the camera, before the camera's storage area is connected to a computer or the Internet.

In another embodiment of the current invention, a standard list of available sorting criteria may used without examining the images on the camera or storage device.

Once a sorting criteria has been determined 104 a sorting size is determined 106. In one embodiment of the current invention, a default sorting size is chosen for each type of available sorting criteria. In another embodiment, a list of sorting sizes would be presented to the user for each type of sorting criteria, for example a list of distances and geographic areas may be presented when location has been selected as the sorting criteria. The user would select a sorting size from the list. In another embodiment, the user could input the desired sorting size, for example typing in a time duration when time had been selected as the sorting criteria. In another embodiment, combinations of the above methods are used, where a default may be supplied, the user may select from a list, or the user may type in a sorting size.

Once a sorting size and sorting criteria has been determined the images are sorted into sets of images 110 that correspond to the sorting criteria and sorting size. Sub-directories or folders are created for each set of images 112 and the sets of images are moved into the corresponding subdirectories 114. In some cases not all the images will fit the criteria to be moved into a set, for example when the sorting size is cities, not all images will have been taken inside a city. In one embodiment, images that do not fit into a set will be moved to the parent or main directory. In another embodiment, a subdirectory will be created for the images that do not fit into one of the sorted sets of images and the images that don't fit into a set will be move into this special subdirectory.

In a preferred embodiment of the current invention, the images would be sorted automatically when the camera or storage device is connected to the computer. Unfortunately the user may already have directories on the computer that contain large numbers of unsorted image files. In one embodiment of the current invention, the user would be able to give an input path or directory to be used to locate the images to be sorted 102. This would allow the user to organize images already contained on their computer. Changing the input directory would also allow the user to specify new locations for images to be sorted when the user moves images to their computer from the camera in non-standard ways. In another embodiment of the current invention, the user could specify a file extension, for example *.jpg. When a file extension has been specified, only files ending in the extension would be sorted.

In a preferred embodiment of the current invention, the location in the file system where the subdirectories are created would be a default location. One default location that could be used is the “my photos” location. Any location in the file system could be used as the default location. In another embodiment of the current invention, the user would be prompted to input a destination location for the subdirectories 108. When the user inputs a destination the subdirectories for the sorted sets of images would be created in the destination location.

This invention was described using images files from digital cameras for ease of understanding. However the described sorting technique can be used for many types of files and is not limited to image files from digital cameras

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of reorganizing data, comprising:
determining a sorting criteria and a sorting size;
determining an input path;
sorting a plurality of data, located by the input path, into sets of data, based on the sorting criteria and sorting size;
creating subdirectories for at least one set of data; and
moving at least one set of data into the corresponding subdirectory.

2. The method of claim 1 where the sorting criteria is the date that the data was saved.

3. The method of claim 1 where the sorting criteria is the location the data was created.

4. The method of claim 3 where the sorting size is a geographic area.

5. The method of claim 4 where the geographic area is at least one of the following:
an address, a city, a state, a country, an island, a county, a region, a town.

6. The method of claim 1 further comprising:
setting an output location;
creating the subdirectories at the output location.

7. The method of claim 1 where the data is electronic images.

8. The method of claim 7 where the sorting criteria is the resolution of the image.

9. The method of claim 1 further comprising:
setting a file type, where the sorting of data at the input location is limited to only the file type selected.

10. The method of claim 1 where the input path is a default location.

11. A computer programmed to reorganize images, comprising:
an input location;
a sorting criteria and a sorting size;
a file structure;
a processor configured to sort a plurality of images, located at the input location, into sets of images, based on the sorting criteria and sorting size;
the processor configured to create a folder for each set of images and move each set of images into the corresponding folder.

12. The computer of claim 11 where the sorting criteria is the date that the image was created.

13. The computer of claim 11 where the sorting criteria is the location the image was created.

14. The computer of claim 13 where the sorting size is a geographic area.

15. The computer of claim 14 where the geographic area is at least one of the following:
an address, a city, a state, a country, an island, a county, a region, a town.

16. The computer of claim 11 where the sorting criteria is the resolution of the image.
